(19) United States
(12) Patent Application Publication
(10) Pub. No.: US 2025/0117686 A1
(43) Pub. Date: Apr. 10, 2025

(54) TECHNIQUES FOR ENERGY USAGE ESTIMATION IN COMPUTING SYSTEMS

(71) Applicant: Red Hat, Inc., Raleigh, NC (US)

(72) Inventors: Huamin Chen, Westboro, MA (US); Yuval Lifshitz, Ra'anana (IL)

(21) Appl. No.: 18/378,508

(22) Filed: Oct. 10, 2023

(51) Int. Cl. G06N 20/00

(52) U.S. Cl. CPC G06N 20/00

(57) ABSTRACT

Tracing data including a plurality of traces for a plurality of operations performed by a distributed computing system on behalf of a plurality of users of a distributed computing system during a period of time is identified. Each trace having latencies for a plurality of segments of a corresponding operation. A set of overall latencies comprising an overall latency for each segment is determined. A set of user latencies including a latency for each segment is determined for each of the plurality of users. A set of energy usage estimates including an energy usage estimate for one or more of the plurality of users is generated, by a processing device, based on the set of overall latencies and the set of user latencies using a machine learning (ML) model.

### TECHNICAL FIELD

Aspects of the present disclosure relate to techniques for energy usage estimation in computing systems and, more particularly, to determining energy usage estimates for users of a distributed computing system.

### BACKGROUND

Distributed computing systems have recently grown in popularity given their improved scalability, performance, resilience, and cost effectiveness. Distributed computing systems generally include a group of nodes (e.g., physical machines) in communication with each other via one or more networks, such as a local area network or the Internet. Examples of distributed computing systems can include cloud computing systems, data grids, and computing clusters. Distributed computing systems can be used for a wide range of purposes, such as for storing and retrieving data, executing software services, etc.

It is common for multiple users to interact with a single distributed computing system to perform various functions. For example, thousands of users may transmit requests to a distributed computing system over the course of a single day to use the system's software services. Examples of such requests can include read requests for reading data, write requests for writing data, deletion requests for deleting data, merge request for merging data, creation requests for creating files or directories, and rename requests for renaming files or directories. As the distributed computing system performs computing operations to respond to these requests, the distributed computing system can consume electrical energy.

Each request transmitted by a user may cause a computing operation including one or more segments to be performed by one or more software services of the distributed computing system. For example, a user may issue a write request to store data in a distributed storage system (e.g., a Hadoop® Distributed File System), which is one type of distributed computing system. In response to receiving the write request, the distributed storage system may implement a computing operation comprising a series of segments. Examples of such segments can include authenticating the user to store the data, partitioning the data, breaking the data into streams, identifying an appropriate storage node on which to store the data, and then actually storing the data to a storage device (e.g., a hard drive or hard disk). Each of these segments may be performed by a different software service in the distributed computing system. Performing these segments of an operation can contribute to the overall energy consumed by the distributed computing system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

To easily identify the discussion of any particular element or act, the most significant digit or digits in a reference number refer to the figure number in which that element is first introduced.

FIG. 1 is a schematic block diagram that illustrates an example system, according to some embodiments of the present disclosure.

FIG. 2 is a block diagram that illustrates an example automated flow of the system, according to some embodiments of the present disclosure.

FIG. 3 is a block diagram that illustrates various aspects of training a machine learning (ML) model for generating energy usage estimates, according to some embodiments of the present disclosure.

FIG. 4 is a flow diagram of a method for generating energy usage estimates, according to some embodiments of the present disclosure.

FIG. 5 is a block diagram of an example system for generating energy usage estimates, according to some embodiments of the present disclosure.

FIG. 6 is a block diagram that illustrates an example system, according to some embodiments of the present disclosure.

### DETAILED DESCRIPTION

Distributed computing systems such as distributed storage systems can handle requests from dozens or hundreds of users each day. Handling these requests can involve performing computing operations including one or more segments, which consumes electrical energy. In some circumstances, a single request for an operation from a single user can trigger a cascade of additional requests and service executions (referred to as segments of the operation), which can each contribute to the overall energy consumption of the distributed computing system. For example, a user may issue a single request for an operation to a gateway associated with the distributed computing system. The gateway may, in turn, interact with multiple operational components (e.g., software services, backend services, etc.) of the distributed computing system that each execute one or more segments of the operation to effectuate an overall process that fulfills the request for the operation. A backend service is a software service (e.g., a microservice, serverless function, or application) executed on the backend of a computer system, as opposed to a frontend service which is a service executed on the frontend of the computer system. Executing each of these segments corresponding to a computing operation may contribute to the overall energy consumption of the distributed computing system.

Because of the complex and cascading interactions between the software services, it can be challenging to estimate energy consumption on a per user basis. For example, conventional systems may estimate energy consumption on a per user basis by counting how many operations are performed on behalf of each user on each operational component (e.g., daemon or container) in a distributed computing system. The ratio of the operation count for a user relative to an overall count of operations performed on behalf of all users can then be utilized to apportion energy usage to each user. However, different operations have different segments (e.g., interactions with one or more backend services to help perform the operation) that utilize different amounts of energy. For example, GET, PUT, and DELETE operations may consume different amounts of energy. In another example, operations on larger objects consume more energy that operations on smaller objects. In yet another example, operations involving encryption consume more energy than operations that do not involve encryption. Thus, using operational counts to determine energy usage of users can results in inaccurate apportionments of energy usage. Adding further complexity, looking into explicit details of each operation and classifying it may require excessive amounts of computing overhead and/or violate privacy policies. These limitations can drastically reduce the usability and applicability of energy usage allocation techniques and systems, contributing to inaccurate energy usage apportionment and inefficient systems, devices, and techniques with limited capabilities. For example, accurately knowing how much of the total energy consumed by the distributed computing system to attribute to each user can be important for various reasons, for example to balance energy loads across the physical infrastructure of the distributed computing system, manage account tiers, and apportion costs.

Embodiments of the present disclosure address the above and other problems by utilizing the latency of segments of operations performed on behalf of users to infer the weight of operations relative to other operations in an accurate, reliable, and secure manner that protects user privacy. The latencies can be used to determine correspond to amounts of time various operational components of a distributed computing system spend performing operations and/or segments of operations. For example, tracing data including latencies corresponding to segments of operations may be utilized to determine overall latencies as well as user latencies for each segment. This data may be provided as input to a machine learning (ML) model to generate energy usage estimates for users in an accurate and energy efficient manner. Further, in many embodiments, the ML model may be trained on tracing data from a majority, or all, operations performed by a distributed computing system during one or more periods of time. However, generating tracing data for operations can require a considerable amount of computing overhead. Accordingly, in production, the ML model may accurately determine energy usage for a period of time based on a tracing data from a sampling of operations performed on behalf of users during the period of time.

In these and other ways, components/techniques described hereby may provide many technical advantages. For example, accurate knowledge of the total energy consumed by the distributed computing system to attribute to each user can be utilized to realized improved balancing of energy loads across the physical infrastructure of distributed computing system, managing account tiers, and apportioning costs. In another example, sampling techniques facilitate efficient determinations of energy usage by reducing computing overhead needed to make the determinations. In yet another example, the techniques described herein can be implemented without having to further modify the software services themselves (e.g., the gateway services or backend services). This can avoid introducing downtime and errors with respect to the software services. Thus, the computer-based techniques of the current disclosure improve the functioning of distributed computing systems as compared to conventional approaches. Further, embodiments disclosed hereby can be practically utilized to improve the functioning of a computer and/or to improve a variety of technical fields including distributed computing, energy usage estimation, privacy, energy load balancing, tracing, and machine learning (e.g., classification and regression trees).

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

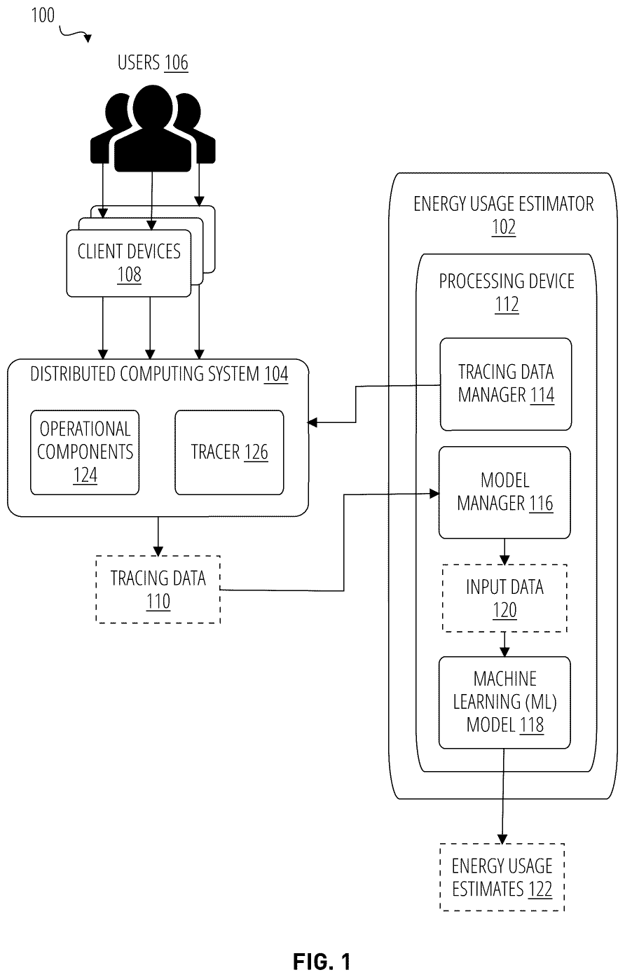

FIG. 1 illustrates an operating environment 100 with an energy usage estimator 102 according to some embodiments. The illustrated embodiment includes energy usage estimator 102 in conjunction with a distributed computing system 104 and a plurality of users 106 interacting with the distributed computing system 104 via client devices 108. The distributed computing system 104 may include a plurality of operational components 124 and a tracer 126. The plurality of operational components 124 may perform various operations and/or segments thereof in the distributed computing system 104 and the tracer 126 may generate tracing data 110 regarding the performance of the various operations and/or segments thereof. The energy usage estimator 102 may include a processing device 112 with a tracing data manager 114, a model manager 116, and an ML model 118. The tracing data manager 114 may interact with the distributed computing system 104 to control various aspects of generation of the tracing data 110, such as the sampling rate. The model manager 116 may transform the tracing data 110 into input data 120. The input data 120 may be provided to the ML model 118 to generate energy usage estimates 122. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, tracing data manager 114 and model manager 116 may be included in different processing devices without departing from the scope of this disclosure. Embodiments are not limited in this context.

The users 106 may interact with the distributed computing system 104 via one or more client devices 108, such as laptop computers, desktop computers, mobile phones, and tablets. In some embodiments, the distributed computing system 104 may include a multi-tenant cloud native system. The client devices 108 can be in communication with the distributed computing system 104 via one or more networks, such as the Internet. The distributed computing system 104 can include any number and combination of operational components 124, such as networked nodes (e.g., physical or virtual machines). For example, the operational components 124 may include at least one of a Hypertext Transfer Protocol (HTTP) front end, a library, or various daemons (e.g., an object store daemon, a storage backend daemon, etc.). In some embodiments, the distributed computing system 104 and/or the operational components 124 thereof may include, or implement, at least one of a container orchestration platform (e.g., Red Hat™ OpenShift™), a software defined storage solution (e.g., a Ceph storage system), a gateway (e.g., a Ceph Object Gateway or Rados Gateway (RGW), a machine learning platform (e.g., Red Hat™ OpenShift™ Data Science (RHODS), data/event stream platforms (e.g., Red Hat™ OpenShift™ Streams), cloud native databases, a distributed storage system (e.g., a Hadoop® Distributed File System), or the like. The users 106 can interact with the distributed computing system 104 to perform operations. For instance, in an example in which the distributed computing system 104 is a distributed storage system, the users 106 can interact with the distributed storage system to store and retrieve data.

The client devices 108 and the distributed computing system 104 can collectively form a client-server architecture. The operational components 124 of distributed computing system 104 can include a gateway for interfacing with the client devices 108. The gateway and the client devices may interact with one another to facilitate operations requested by users 106. For example, a gateway included in energy usage estimates 122 may include one or more gateway services, with which a client device can interact to initiate execution of an operation (e.g., a GET, PUT, or DELETE operation). Examples of the operations can include a data storage task or a data retrieval task. In response to the interaction, the gateway can transmit a corresponding request to one or more backend services included in operational components 124, such as software services.

The request may trigger the execution of the one or more backend services. For example, the request may trigger the execution of a first software service, which in turn may trigger the execution of a second software service, etc. Thus, a single request may trigger a cascading sequence of service executions on the backend, which may be referred to as segments of an operation. For example, segments of an operation may include at least one of utilization of an HTTP frontend, utilization of an object store daemon, utilization of a library (e.g., that communicates with a storage backend daemon), communications between different operational components (e.g., on a wire between daemons), or utilization of a storage backend daemon.

In the illustrated embodiment, the tracer 126 may generate a trace describing the series of service executions. For example, a single trace can include unique identifiers of each operation and/or segment (e.g., software service) that was executed in the set of segments comprising the operation. The trace can also include other information, such as a user identifier that uniquely identifies the user that initiated the request and latencies (e.g., time stamps) that identify an amount of time spent on each segment of the operation. The tracer 126 may store each trace as its own entry within tracing data 110 (e.g., a log). These entries can be referred to as tracing entries because they are entries that include traces.

The model manager 116 may utilize the tracing data 110 to produce input data 120 for the ML model 118. For example, model manager 116 may utilize tracing data 110 to determine an overall latency for segments performed by distributed computing system 104 on behalf of all of the users 106 and user latencies for segments performed by distributed computing system 104 on behalf of each of the users 106. The input data 120 may be provided to the ML model 118 and the ML model 118 may generate energy usage estimates 122 based on the input data 120. In various embodiments, the model manager 116 may select ML model 118 from a plurality of ML models. For example, the model manager 116 may select ML model 118 based on one or more characteristics of the operations being performed on behalf of users 106. In another example, the users 106 may be selected for use with the ML model 118 based on their historical workloads. Accordingly, as will be described in more detail below, energy usage estimator 102 may utilize different ML models for different groups of users and/or different workload groupings. In some embodiments, ML models may be selected, at least in part, based on context data, such as time of year.

In various embodiments, the tracing data manager 114 may control one or more operational parameters of the tracer 126, such as sampling frequency or percentage. For example, the tracing data manager 114 may configure the tracer 126 to generate tracing data 110 for all operations performed by the distributed computing system 104 to generate tracing data utilized to train the ML model 118. However, once the ML model 118 is trained, it may only utilize tracing data 110 from a portion of the operations performed to infer energy usage estimates 122, such as to reduce computing overhead. Accordingly, the tracing data manager 114 may configure the tracer 126 to generate tracing data 110 for 5% of operations during production.

It should be noted that although a single processing device 112 is depicted in FIG. 1 for simplicity, other embodiments may include multiple processing devices, storage devices, or devices. Processing device 112 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 160a, b may also include one or more special-purpose processing devices such as an application specific integrated circuit (ASIC), a field programmable gate array (FPGA), a digital signal processor (DSP), network processor, or the like. Further details regarding generation of energy usage estimates 122 will be discussed below.

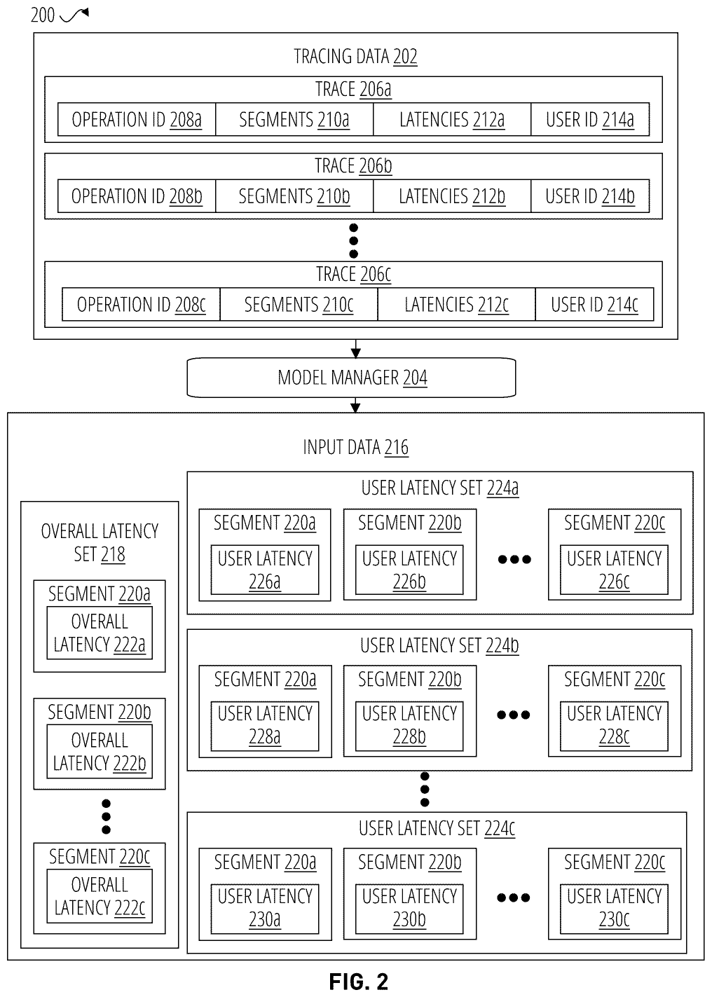

FIG. 2 illustrates a block diagram 200 of an example automated flow of a model manager 204 of an energy usage estimator. More specifically, model manager 204 may generate input data 216 based on tracing data 202. The tracing data 202, which may be the same or similar to tracing data 110, includes a plurality of traces 206a, 206b, 206c (collectively referred to as traces 206). The input data 216, which may bet the same or similar to input data 120, includes an overall latency set 218 and a plurality of user latency sets 224a, 224b, 224c (collectively referred to as user latency sets 224). In many embodiments, the input data 216 may be provided to a ML model to generate energy usage estimates. In some embodiments, the input data 216 may be utilized to train ML models to generate energy usage estimates. One or more components of FIG. 2 may be the same or similar to one or more other components disclosed hereby. For example, one or more of tracing data 202, model manager 204, and input data 216 may be the same or similar to one or more of tracing data 110, model manager 116, and input data 120, respectively. Further, aspects discussed with respect to various components in FIG. 2 may be implemented by one or more other components from one or more other embodiments without departing from the scope of this disclosure. Embodiments are not limited in this context.

In various embodiments, the tracing data 202 may be generated based on operations performed by a distributed computing system (e.g., distributed computing system 104). The tracing data 202 may include a trace for each operation tracked or sampled by a tracer (e.g., tracer 126). Each trace may correspond to an operation performed by a distributed computing system, be associated with a user the operation was performed on behalf of, and include a set of segments of the operation with a set of latencies corresponding to each segment of the operation. In the illustrated embodiment, trace 206a includes operation identifier (ID) 208a, segments 210a, latencies 212a, and user ID 214a; trace 206b includes operation ID 208b, segments 210b, latencies 212b, user ID 214b; and trace 206c includes operation ID 208c, segments 210c, latencies 212c, and user ID 214c. In some embodiments, the set of segments (and corresponding set of latencies) for each of the operations of traces 206 may include at least one of utilization of an HTTP frontend, utilization of an object store daemon, utilization of a library (e.g., that communicates with a storage backend daemon), communications between different operational components (e.g., on a wire between daemons), or utilization of a storage backend daemon.

The model manager 204 may utilize the tracing data 202 to generate overall latency set 218. The model manager 204 may determine the overall latency in tracing data 202 for each of one or more segments 220a, 220b, 220c (collectively referred to as segments 220) included in the tracing data 202 to generate overall latencies 222a, 222b, 222c (collectively referred to as overall latencies 222). For example, model manager 204 may determine the sum of latencies in tracing data 202 for each different type of segment performed. In the illustrated embodiment, the overall latency set 218 includes segment 220a with overall latency 222a, segment 220b with overall latency 222b, and segment 220c with overall latency 222c. Thus, each of the overall latencies may indicate an amount of time the distributed computing system spent performing a type of segment in operations included in the tracing data 202.

Similarly, the model manager 204 may utilize the tracing data 202 to generate user latency sets 224. Each of the user latency sets may include a user latency for each of the segments 220. Thus, each user latency set 224 may indicate an amount of time the distributed computing system spent performing each segment on behalf of a specific user (or grouping of users) in operations included in the tracing data 202. In the illustrated embodiment, user latency set 224a includes user latency 226a for segment 220a, user latency 226b for segment 220b, and user latency 226c for segment 220c; user latency set 224b includes user latency 228a for segment 220a, user latency 228b for segment 220b, and user latency 228c for segment 220c; and user latency set 224c includes user latency 230a for segment 220a, user latency 230b for segment 220b, and user latency 230c for 220c.

In various embodiments, some segments may be performed for multiple different operations, while other segments may be unique to particular operations. However, in many embodiments, the model manager 204 may determine an overall latency for a particular segments based on the sum of all latencies for that particular segment, regardless of the type of the corresponding operation that included the segment. For example, all operations may include a segment corresponding to utilization of the HTTP front end of an object store daemon, but only some operations may include utilization of a storage backend daemon.

In some embodiments, the latencies included in the tracing data 202 and/or input data 216 may include time stamps associated with different segments of the operation. In one embodiment, model manager 204 may utilize time stamps included in tracing data 202 as latencies to generate durations included in input data 216 as latencies. In some embodiments, the input data 216 may include vector data generated by model manager 204 based on tracing data 202. For example, model manager 204 may generate a feature vector for each segment with dimensions corresponding to the overall latency and each of the user latencies. In some embodiments, the model manager 204 may utilize different formats based on whether the input data 216 will be used for training a ML model or making inferences with a ML model.

In one embodiment, the overall and user latencies for the set of segments 220 may include at least one of a first latency indicating how much time was spent in an HTTP frontend of an object store daemon, a second latency indicating how much time was spent in the object store daemon, a third latency indicating how much time was spent in a library that communicates with the storage backend daemon, a fourth latency indicating how much time was spent on the wire between daemons, or a fifth latency indicating how much time was spent in the storage backend daemon.

In some embodiments, model manager 204 may generate multiple sets of input data 216 for traces corresponding to different types of workloads and/or payloads. In some such embodiments, the model manager 204 may select a ML model for use in conjunction with the different sets of input data 216. In one embodiment, the different sets of input data 216 may be generated according to users. For example, various users may be associated with different types of workloads and/or payloads, such as based on account classifications or mappings determined based on historical operations.

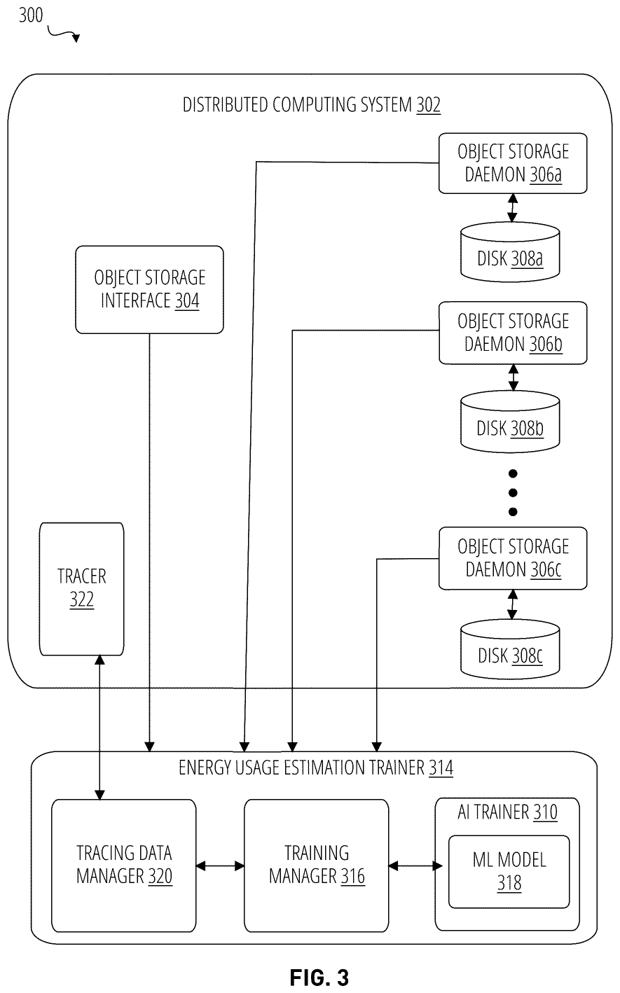

FIG. 3 illustrates various aspects of training a machine learning for generating energy usage estimates according to some embodiments. The illustrated embodiment includes an operating environment 300 with a distributed computing system 302 and energy usage estimation trainer 314. The distributed computing system 302 has a tracer 322 and a plurality of operational components including an object storage interface 304, a first object storage daemon 306a communicatively coupled to a first disk 308a, a second object storage daemon 306b communicatively coupled to a second disk 308b, and a third object storage daemon 306c coupled to a third disk 308c. The energy usage estimation trainer 314 may include a tracing data manager 320, a training manager 316, and an AI trainer 310 with an ML model 318. One or more components of FIG. 3 may be the same or similar to one or more other components disclosed hereby. For example, one or more of distributed computing system 302, tracing data manager 320, and training manager 316 may be the same or similar to one or more of distributed computing system 104, tracing data manager 114, and model manager 116, respectively. Further, aspects discussed with respect to various components in FIG. 3 may be implemented by one or more other components from one or more other embodiments without departing from the scope of this disclosure. For example, energy usage estimation trainer 314 may not be communicatively coupled with distributed computing system 302 and, instead, training data may be provided directly to the energy usage estimation trainer 314. In another embodiment, one or more operational aspects of energy usage estimation trainer 314 may be incorporated into energy usage estimator 102. Embodiments are not limited in this context.

In various embodiments, energy usage estimation trainer 314 may be utilized to train machine learning models for generating energy usage estimates. In some embodiments, the machine learning models may include classification and regression tree (CART) models. The tracing data manager 320 may configure tracer 322 to cause the distributed computing system 302 to generate tracing data for each of the object storage interface 304 and the object storage daemons 306. For example, tracing data manager 320 may configure tracer 322 to cause the distributed computing system 302 to generate tracing data for all operations performed by the distributed computing system 302 during a period of time.

The training manager 316 may receive the tracing data from the distributed computing system 302 and generate training data based on the tracing data. The training data may then be provided to the AI trainer 310 to use in generating ML model 318. In many embodiments, a portion of the training data may be withheld from training and, instead, utilized to validate the ML model 318. In some embodiments, the training manager 316 may generate different sets of training data for different types of workloads and/or payloads associated with different sets of users. For example, training manager 316 may classify users based on historical operations performed by the user. In various embodiments, training manager 316 may generate mappings of users to different ML models.

The different sets of training data may be utilized to train different ML models to generate energy usage estimates for different types of workloads, payloads, and/or sets of users. For example, at least one of a first ML model may be trained to infer energy usage estimates for users that utilize the distributed computing system 302 for storage of personal data, a second ML model may be trained to infer energy usage estimates for users that utilize the distributed computing system 302 for image processing, or a third ML model may be trained to infer energy usage estimates for users that utilize the distributed computing system 302 for a web directory. In one embodiment, the energy usage estimation trainer 314 may generate metadata, such as mappings, regarding each of the ML models. This metadata may be utilized during production to select the appropriate ML model to use in different scenarios, such as for different workloads, payloads, and/or sets of users. In some embodiments, ML models may be periodically retrained, such as monthly or yearly. In various embodiments, ML models may be retrained based on thresholds, such as shifts in the types of workloads.

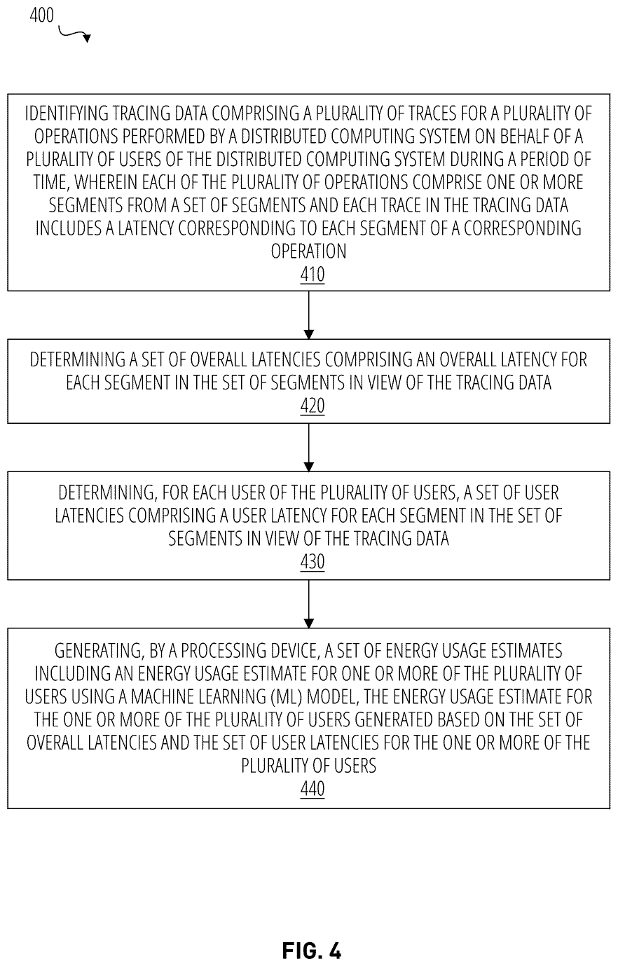

FIG. 4 is a flow diagram of a method 400 of generating energy usage estimates, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by energy usage estimator 102 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic identifies tracing data including a plurality of traces for a plurality of operations performed by a distributed computing system on behalf of a plurality of users of the distributed computing system. Further, each of the plurality of operation may include one or more segments from a set of segments and each trace in the tracing data may include a latency corresponding to each segment of a corresponding operation. For example, model manager 204 may identify tracing data 202 including a plurality of traces 206 for a plurality of operations performed by distributed computing system 104. Each of the traces 206 may include an operation ID, a set of segments and latencies corresponding to the segments in the operation from the set of segments 220. The plurality of operations may include at least one of GET, PUT, or DELETE commands. In some embodiments, the plurality of users may not include all users associated with traces in the tracing data. For example, the plurality of users may correspond to a grouping of users.

At block 420, the processing logic determines a set of overall latencies including an overall latency for each segment in the set of segments in view of the tracing data. For example, model manager 204 may determine overall latency set 218 in view of tracing data 202. Further, overall latency set 218 may include an overall latency for each segment in the set of segments 220. In other words, the set of overall latencies may include an overall amount of time the distributed computing system utilized to perform each segment in the set of segments included in the tracing data for a period of time. As previously discussed, the tracing data may only include a sampling of segments performed during the period of time. In various embodiments, the set of segments may include at least one of time spent in a hypertext transfer protocol frontend of the distributed computing system, time spent in an object store daemon of the distributed computing system, time spent in a storage backend daemon of the distributed computing system, time spent in a library in communication with the storage backend daemon, or time spent between daemons of the distributed computing system.

At block 430, the processing logic determines a set of user latencies for each user in the plurality of users. For example, model manager 204 may generate user latency sets 224 in view of tracing data 202. Further, each of the user latency sets may include a user latency for each segment in the set of segments 220 included in the tracing data for the period of time. In other words, the set of user latencies for each user may include a total amount of time the distributed computing system utilized to perform each segment in the set of segments included in the tracing data on behalf of a corresponding user for the period of time For example, user latency set 224a may correspond to a first user (or group of users, such as a group of users for an enterprise client) and include a first user latency 226a for a first segment 220a in the set of segments 220, a second user latency 226b for a second segment 220b in the set of segments 220, and a third user latency 226c for a third segment 220c in the set of segments 220.

At block 440, the processing logic generates a set of energy usage estimates including an energy usage estimate for one or more of the plurality of users using a machine learning model. Further, the energy usage estimate for the one or more of the plurality of users may be generated based on the set of overall latencies and the set of user latencies for the one or more users of the plurality of users. For example, model manager 116 may provide input data 120 including a set of overall latencies and a set of user latencies for one or more users of the plurality of users to ML model 118 to generate energy usage estimates 122 for the one or more users. In some embodiments, the ML model may include a classification and regression tree model. In various embodiments, the energy usage estimate for the one or more of the plurality of users may include an estimated computer processing unit utilization for the one or more of the plurality of users. In many embodiments, the distributed computing system may have historically performed operations with similar payload characteristics as the plurality of operations and the ML model may be selected based on the similar payload characteristics. In various embodiments, the ML model is trained on historical tracing data corresponding to a plurality of historical operations performed by the distributed computing system on behalf of at least a portion of the plurality of users of the distributed computing system.

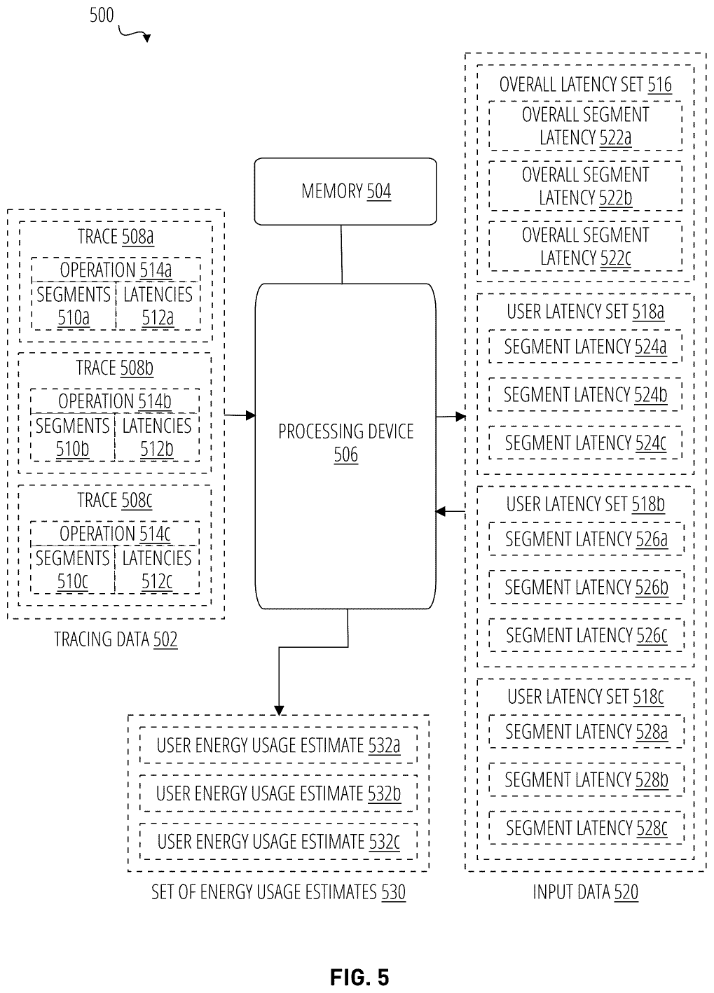

FIG. 5 illustrates a block diagram of a system 500 for generating energy usage estimates according to some embodiments. In the illustrated embodiment, system 500 includes tracing data 502, memory 504, processing device 506, input data 520, and a set of energy usage estimates 530. The processing device 506 may be operatively coupled to the memory 504. It should be noted that some components of system 500 are shown for illustrative purposes only and are not physical components of the system 500, such as tracing data 502, input data 520, and the set of energy usage estimates 530. One or more components of FIG. 5 may be the same or similar to one or more other components disclosed hereby. For example, processing device 506 may be the same or similar to processing device 112. Further, aspects discussed with respect to various components in FIG. 5 may be implemented by one or more other components from one or more other embodiments without departing from the scope of this disclosure. For example, a first processing device may generate input data 520 based on tracing data 502 and a second processing device may generate the set of energy usage estimates 530 based on input data 520. Embodiments are not limited in this context.

In system 500, tracing data 502 includes trace 508a corresponding to operation 514a and including segments 510a and latencies 512a; trace 508b corresponding to operation 514b and including segments 510b and latencies 512b; and trace 508c corresponding to operation 514c and including segments 510c and latencies 512c. In various embodiments, the tracing data may be generated by a distributed computing system (e.g., operational components 124 and/or tracer 126 of distributed computing system 104). The processing device 506 may generate input data 520 based on the tracing data 502.

The input data 520 may include overall latency set 516, first user latency set 518a, second user latency set 518b, and third user latency set 518c. The overall latency set 516 may include overall segment latency 522a corresponding to a first segment in a set of segments in operations of tracing data 502, overall segment latency 522b corresponding to a second segment in the set of segments, and overall segment latency 522c corresponding to a third segment in the set of segments. The first user latency set 518a may correspond to latencies for a first user and include segment latency 524a corresponding to the first segment in the set of segments, segment latency 524b corresponding to the second segment in the set of segments, and segment latency 524c corresponding to the third segment in the set of segments. The second user latency set 518b may correspond to latencies for a second user and include segment latency 526a corresponding to the first segment in the set of segments, segment latency 526b corresponding to the second segment in the set of segments, and segment latency 526c corresponding to the third segment in the set of segments. The third user latency set 518b may correspond to latencies for a third user and include segment latency 528a corresponding to the first segment in the set of segments, segment latency 528b corresponding to the second segment in the set of segments, and segment latency 528c corresponding to the third segment in the set of segments.

The processing device 506 may generate the set of energy usage estimates 530 based on the input data 520, such as using a ML model (e.g., ML model 118). The energy usage estimates for the one or more of the plurality of users may include an estimated computer processing unit utilization for the one or more of the plurality of users. The set of energy usage estimates 530 may include a first user energy usage estimate 532a corresponding to the first user, a second user energy usage estimate 532b corresponding to the second user, and a third user energy usage estimate 532c corresponding to the third user. In many embodiments, the set of energy usage estimates 530 may utilized for at least one of balancing energy loads across the physical infrastructure of a distributed computing system, managing account tiers and/or service levels, or apportioning costs associated with operation of a distributed computing system.

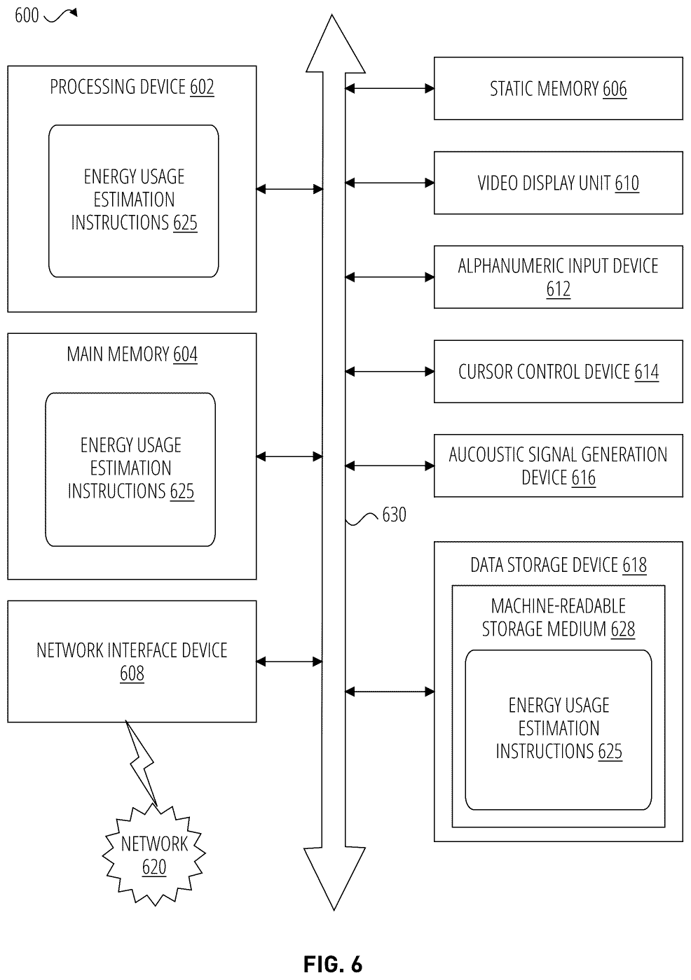

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602 (e.g., a general purpose processor, a PLD, etc.), a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a machine-readable storage medium 628 on which may be stored one or more sets of energy usage estimation instructions 625 that may include instructions for a component (e.g., energy usage estimator 102, tracing data manager 114, model manager 116, and/or ML model 118) for carrying out the operations described herein, in accordance with one or more aspects of the present disclosure. Energy usage estimation instructions 625 may also reside, completely or at least partially, within main memory 604 and/or within processing device 602 during execution thereof by computing device 600, main memory 604 and processing device 602 also constituting computer-readable media. The energy usage estimation instructions 625 may further be transmitted or received over a network 620 via network interface device 608.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “identifying”, “receiving,” “determining,” “generating,” “utilizing”, “producing”, “executing”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
identifying tracing data comprising a plurality of traces for a plurality of operations performed by a distributed computing system on behalf of a plurality of users of the distributed computing system during a period of time, wherein each of the plurality of operations comprise one or more segments from a set of segments and each trace in the tracing data includes a latency corresponding to each segment of a corresponding operation;
determining a set of overall latencies comprising an overall latency for each segment in the set of segments in view of the tracing data;
determining, for each user of the plurality of users, a set of user latencies comprising a user latency for each segment in the set of segments in view of the tracing data; and
generating, by a processing device, a set of energy usage estimates including an energy usage estimate for one or more of the plurality of users using a machine learning (ML) model, the energy usage estimate for the one or more of the plurality of users generated based on the set of overall latencies and the set of user latencies for the one or more of the plurality of users.

2. The method of claim 1, wherein the set of segments include at least one of time spent in a hypertext transfer protocol frontend of the distributed computing system, time spent in an object store daemon of the distributed computing system, time spent in a storage backend daemon of the distributed computing system, time spent in a library in communication with the storage backend daemon, or time spent between daemons of the distributed computing system.

3. The method of claim 1, wherein the set of overall latencies includes an overall amount of time the distributed computing system utilized to perform each segment in the set of segments included in the tracing data for the period of time.

4. The method of claim 1, wherein the set of user latencies for each user includes a total amount of time the distributed computing system utilized to perform each segment in the set of segments included in the tracing data on behalf of a corresponding user for the period of time.

5. The method of claim 1, wherein the ML model comprises a classification and regression tree model.

6. The method of claim 1, wherein the plurality of operations corresponding to the tracing data comprises a sampling of total operations performed by the distributed computing system on behalf of the plurality of users of the distributed computing system during the period of time.

7. The method of claim 1, wherein the plurality of operations comprise at least one of GET, PUT, or DELETE commands.

8. A system comprising:
a memory; and
a processing device, operatively coupled to the memory, to:
identify tracing data comprising a plurality of traces for a plurality of operations performed by a distributed computing system on behalf of a plurality of users of the distributed computing system during a period of time, wherein each of the plurality of operations comprise one or more segments from a set of segments and each trace in the tracing data includes a latency corresponding to each segment of a corresponding operation;
determine a set of overall latencies comprising an overall latency for each segment in the set of segments in view of the tracing data;
determine, for each user of the plurality of users, a set of user latencies comprising a user latency for each segment in the set of segments in view of the tracing data; and
generate a set of energy usage estimates including an energy usage estimate for one or more of the plurality of users using a machine learning (ML) model, the energy usage estimate for the one or more of the plurality of users generated based on the set of overall latencies and the set of user latencies for the one or more of the plurality of users.

9. The system of claim 8, wherein the set of segments include at least one of time spent in a hypertext transfer protocol frontend of the distributed computing system, time spent in an object store daemon of the distributed computing system, time spent in a storage backend daemon of the distributed computing system, time spent in a library in communication with the storage backend daemon, or time spent between daemons of the distributed computing system.

10. The system of claim 8, wherein the set of overall latencies includes an overall amount of time the distributed computing system utilized to perform each segment in the set of segments included in the tracing data for the period of time.

11. The system of claim 8, wherein the set of user latencies for each user includes a total amount of time the distributed computing system utilized to perform each segment in the set of segments included in the tracing data on behalf of a corresponding user for the period of time.

12. The system of claim 8, wherein the ML model comprises a classification and regression tree model.

13. The system of claim 8, wherein the plurality of operations corresponding to the tracing data comprises a sampling of total operations performed by the distributed computing system on behalf of the plurality of users of the distributed computing system during the period of time.

14. The system of claim 8, wherein the plurality of operations comprise at least one of GET, PUT, or DELETE commands.

15. A non-transitory computer-readable storage medium including instructions that, when executed by a processing device, cause the processing device to:
identify tracing data comprising a plurality of traces for a plurality of operations performed by a distributed computing system on behalf of a plurality of users of the distributed computing system during a period of time, wherein each of the plurality of operations comprise one or more segments from a set of segments and each trace in the tracing data includes a latency corresponding to each segment of a corresponding operation;
determine a set of overall latencies comprising an overall latency for each segment in the set of segments in view of the tracing data;
determine, for each user of the plurality of users, a set of user latencies comprising a user latency for each segment in the set of segments in view of the tracing data; and
generate, by the processing device, a set of energy usage estimates including an energy usage estimate for one or more of the plurality of users using a machine learning (ML) model, the energy usage estimate for the one or more of the plurality of users generated based on the set of overall latencies and the set of user latencies for the one or more of the plurality of users.

16. The non-transitory computer-readable storage medium of claim 15, wherein the set of segments include at least one of time spent in a hypertext transfer protocol frontend of the distributed computing system, time spent in an object store daemon of the distributed computing system, time spent in a storage backend daemon of the distributed computing system, time spent in a library in communication with the storage backend daemon, or time spent between daemons of the distributed computing system.

17. The non-transitory computer-readable storage medium of claim 15, wherein the set of overall latencies includes an overall amount of time the distributed computing system utilized to perform each segment in the set of segments included in the tracing data for the period of time.

18. The non-transitory computer-readable storage medium of claim 15, wherein the set of user latencies for each user includes a total amount of time the distributed computing system utilized to perform each segment in the set of segments included in the tracing data on behalf of a corresponding user for the period of time.

19. The non-transitory computer-readable storage medium of claim 15, wherein the ML model comprises a classification and regression tree model.

20. The non-transitory computer-readable storage medium of claim 15, wherein the plurality of operations corresponding to the tracing data comprises a sampling of total operations performed by the distributed computing system on behalf of the plurality of users of the distributed computing system during the period of time.
